(19) United States
(12) Patent Application Publication
(10) Pub. No.: US 2002/0070529 A1
(43) Pub. Date: Jun. 13, 2002

(54) Alignment device for a trailer hitch

(76) Inventor: Daniel Louis Dravecz, Naples, FL (US)

Correspondence Address: Daniel Louis DRAVECZ, 1425 Curlew Ave, Naples, FL, 34102, US

(21) Appl. No.: 09/733,711

(22) Filed: Dec. 11, 2000

(51) Int. Cl. B60D 1/00

(52) U.S. Cl. 280/477; 280/511

(57) ABSTRACT

The invention is directed to a visual alignment device useful to aid a driver of a towing vehicle to properly align the ball of a hitch of the towing vehicle to a socket on the trailer to be towed. For this purpose, an upstanding rod is mounted over the ball of the hitch but not in contact therewith. This is accomplished by the use of a C-shaped clamp which is clamped to the neck of the ball mounted to the hitch. Another upstanding rod is mounted on the tongue of the trailer by being clamped on the surface of the inverted socket destined to receive the ball of the hitch. By visually aligning the tops of said upstanding rods with each other, the driver of the towing vehicle is able to align the ball of the hitch and the socket of the trailer with each other to obtain a driving connection when connected to each other.

### CROSS REFERENCE TO RELATED APPLICATIONS

None

### STATEMENT REGARDING FED SPONSORED R & D

None

### REFERENCE TO MICROFICHE APPENDIX

None

### BACKGROUND OF THE INVENTION

The present invention relates to a visual aid device for helping the driver of a towing vehicle in connection with a trailer to properly align the ball of the hitch with the socket on the tongue of a trailer to visually align the same before a driving connection can be made. In most cases, if the driver is by him- or herself, it all depends on a hit and miss trial bases because the driver cannot see either the hitch or the tongue of the trailer from the seat of the towing vehicle from which the connection is to be made. A second person can be of some help because that person would give instructions to the driver when the towing vehicle is backing up.

The present invention is based on a visual aid device consisting of upstanding rods that visually have to be brought together adjacent to each other to indicate a correct alignment of the ball on the hitch and the socket on the tongue of the trailer.

### DESCRIPTION OF THE PRIOR ART

Various devices have been designed to facilitate connecting a towing vehicle to a trailer. Most of the devices involve a mirror system and therefore, are considered to be visual aid devices which permit the driver a direct visual observation of the state of the alignment of the ball of the hitch on the towing vehicle relative to the location of the socket on the tongue of the trailer. The following US Patents show such aid devices involving the use of a mirror: U.S. Pat. Nos. 4,905,376; 4,925,287; 4,951,913; 5,11,342; 5,180,182 and 5,487,101.

U.S. Pat. No. 5,769,443 also shows an alignment guide assembly for trailer hitches. It also involves the use of upstanding rods as visual aids. However, a disadvantage of using this visual aid device is that it takes several steps on part of the driver of the towing vehicle in order to make a driving connection. First of all, the upstanding rod on the towing vehicle is mounted directly on the ball of the hitch of the towing vehicle by way of a cup surrounding the ball. Thus, when a visual connection has been made, the driver of the towing vehicle has to first get out of the vehicle to remove the cup with the upstanding rod from the ball and then to move the towing vehicle into its final position. Secondly, the upstanding rod on the tongue of the trailer has to be mounted on the tongue by special hardware. That is, a dovetail action plate has to be mounted on the tongue first in order to receive the parts that hold the upstanding rod in its place. The parts that hold the upstanding rod on the trailer in place also include an inverted dovetail plate which matches the dovetail plate on the hitch. While these various components seem to achieve the goals contemplated, they are quite complicated, cumbersome and expensive and still not very accurate.

### OBJECTS OF THE INVENTION

An object of the invention is to simplify the orientation of a ball on a hitch of a towing vehicle relative to the socket on a tongue of a trailer when the towing vehicle is backing up to make a driving connection with the trailer. This is simply accomplished by mounting an upstanding rod on the hitch of the towing vehicle and by mounting an upstanding rod on the tongue of the trailer. When the two rods are visually aligned adjacent to each other, because the driver of the towing vehicle is maneuvering the vehicle, the ball and the socket are accurately aligned also with each other in a vertical position without having to make any further adjustments by moving the towing vehicle or by having to move the trailer.

### BRIEF DESCRIPTION OF THE DRAWINGS

FIG. 1 is a perspective view of a hitch and a trailer just prior to being aligned;

FIG. 2 shows a C-shaped component prior to being mounted on the hitch;

FIG. 3 shows a component prior to being mounted on the tongue of a trailer;

FIG. 4 illustrates two upstanding rods having various mechanical elements thereon.

### DETAILED DESCRIPTION OF THE INVENTION

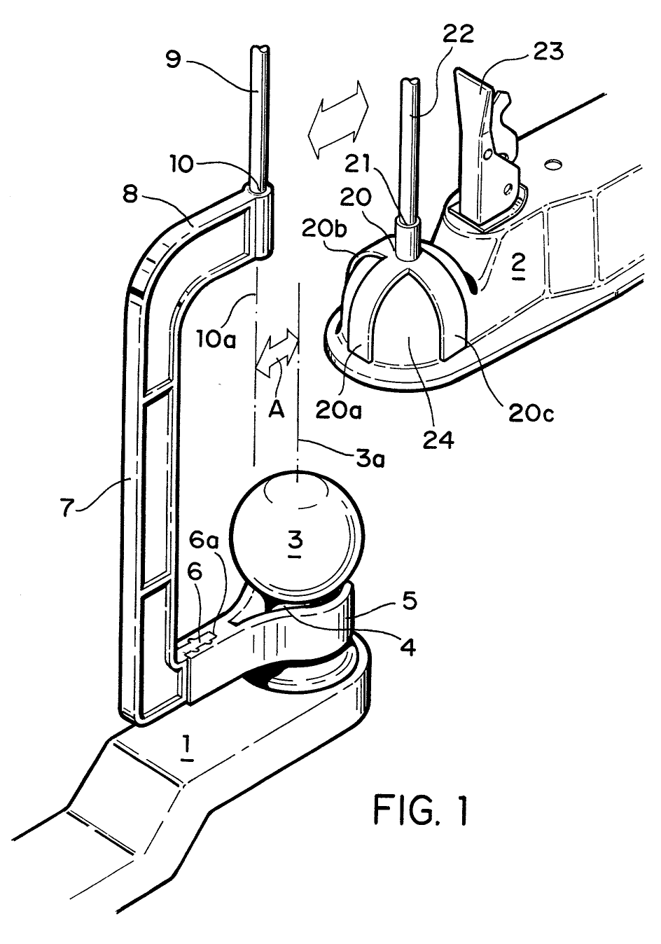

In FIG. 1 there is shown the hitch 1 which is mounted on a towing vehicle (not shown). The towing vehicle can take any shape and form such as a passenger car, an SUV, a van or a Pick-up truck etc. The other component of the towing system is shown at 2 as the tongue of the vehicle to be towed.

On the hitch 1, there is mounted a hitch ball 3 as is well known. As is also well known, the hitch ball 3 has a neck 4 below the ball 3. This neck is being used to mount a C-shaped strut or support 7. The C-shaped strut is clamped to the neck 4 in an upstanding position by way of a yoke or clamp 5. The yoke is separably mounted to the strut by key 6 integral with the strut 7 and a key way 6a in the yoke 5. The key way 6a includes a bottom so that the key cannot fall out of the key once contained therein. On the other hand, the yoke 5 could be an integral part of the strut 7 as being cast in one piece therewith. The strut 7 has an upper arm 8 which is parallel and coextensive with the lower yoke 5. At the free end of the arm an orifice 10 has been provided to receive an upstanding rod 9 therein, which will explained below. The tongue 2 of the vehicle to be towed has an inverted socket 24 therein which will be received over the ball 3 and once received therein will be locked around the ball 3 by way of a clamping mechanism 23. This is well known in the hitch/trailer art and is of a standard shape and size. The inventive concept takes advantage of this fact.

A three-pronged clamp 20 fits over the surface of the inverted socket 24 and remains in that position by way of a friction fit. The clamp 20 has three arms 20a, 20b and 20c. At the apex of this clamp 20 an orifice 21 has been provided for the purpose of receiving another upstanding rod 22. The visual alignment of both rods 9 and 22 will be explained below.

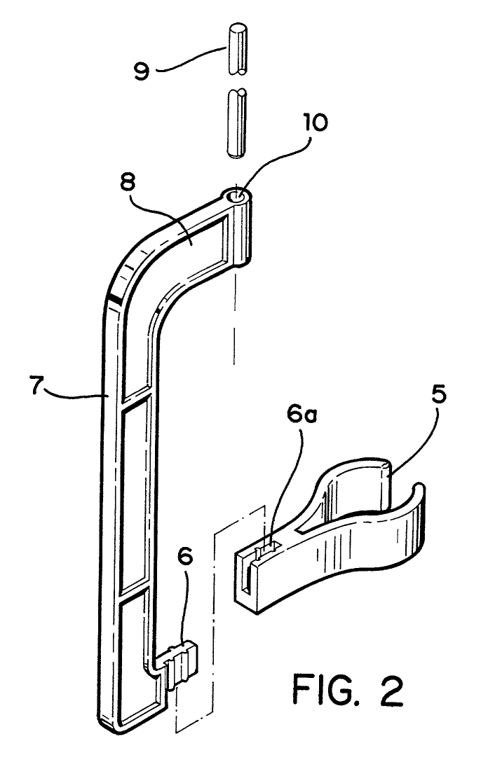

FIG. 2 merely shows the details of the C-shaped strut by itself with no new elements having been added.

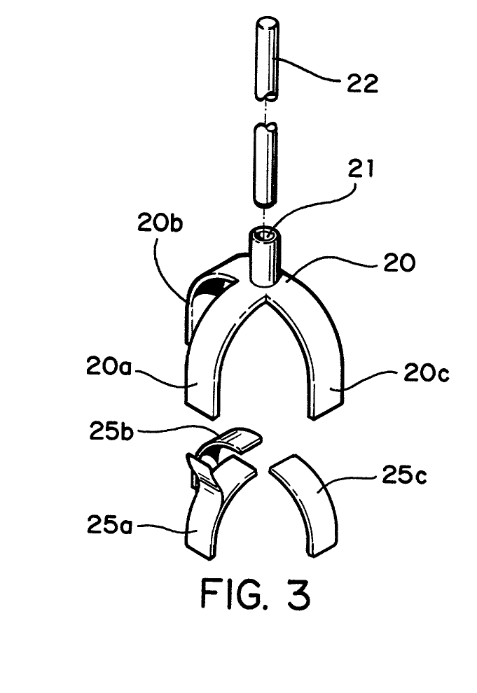

Turning now to FIG. 3, the multi-armed socket clamp 20 is shown with its three clamping legs 20a, 20b and 20c which clamp to the inverted socket outline 24 by way of a friction fit. In most instances this friction fit will suffice because no other forces will be imparted to the clamp 20 during an attempt to align the towing vehicle and the trailer. However, to be sure that a friction fit really holds, magnetic devices can be used to assure a precision fit and clamping action. To this end, magnetic patches 25a, 25b and 25c can be attached to the clamp legs 20a, 20b and 20c, respectively. Each of the magnetic patches can be attached to each of the legs, respectively, by adhesive peel-offs, shown perspectively on magnet strip 25a. In FIG. 3, there is further shown an upstanding orifice 21 to receive an upstanding rod 22 therein.

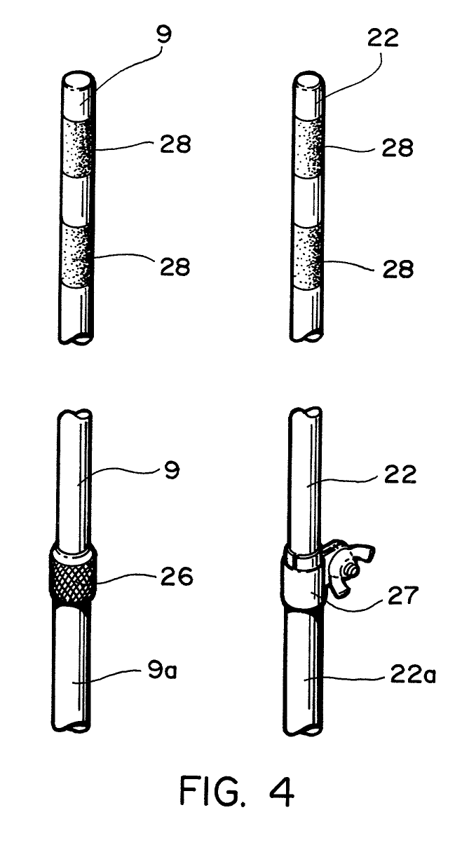

FIG. 4 illustrates the two upstanding rods 9 and 22 having various modifications thereon. It is desirable that the two upstanding rods 9 and 22 be telescoping within each other. This is so, because the two rods 9 and 22 are adjustable in height depending on the type and height of the towing vehicle. For example, a regular passenger vehicle requires a low height of visually aligning the upstanding rods 9 and 22. On the other hand, a van will require a much greater height of the upstanding rods so that they can be visually aligned. Also, it is desirable to keep the alignment system in as low an overall size as is possible so that the alignment system can be collapsed for storage purposes. To this end, FIG. 4 shows different versions of collapsing the upstanding rods into smaller lengths. At 26 there is shown one embodiment which constitutes a compression fitting which can easily be manipulated to either tighten or loosen the fitting so that the various sections 9 and 9a of the rod can be adjusted at different heights. Another embodiment is shown at 27 where a simple clamp 27 is employed with a wing nut to accomplish an adjusting length result. The telescoping sections are shown at 22 and 22a. At the upper ends of the upstanding rods 9 and 22 it is desirable to attach reflecting tapes 28 so that the upper ends of the rods are visible in low light or no light at all because the lights of the towing vehicle would reflect from these reflectors.

### SUMMARY OF THE INVENTION

From all of the above it can now be seen that the alignment device of the invention makes it extremely simple and efficient to hook up a trailer to the hitch of a towing vehicle only by one person. The person does not have to leave the seat of the towing vehicle to accomplish the desired result. Returning to FIG. 1, there is shown an arrow A which indicates the difference of the distance between the axis 10a of the orifice 10 and the axis 3a of the ball 3. There has to be a difference A, otherwise, the axes of the upstanding rods would coincide, they would also collide with each other during the backing up of the towing vehicle while a precise alignment of the ball 3 of hitch 1 and the socket 24 has not yet been achieved. Because of the difference (arrow A), if the upstanding rod 22 is directly over the axis of the ball 3, the other upstanding rod 9 would be precisely over the axis 3a of the ball 3 and the upstanding rods 9 and 22 would simply be touching or collide with each other. Therefore, the upper arm 8 of the C-shaped strut 7 has to be shorter by the distance of arrow A which is the diameter of the upstanding rods 9 and 22.

What I claim is:

1. A visual alignment device for aligning a hitch of a towing vehicle with a tongue of a trailer to be towed including a ball on said hitch, said ball having a neck connecting said ball to said hitch, said tongue on said trailer having an inverted socket to receive said ball therein when said ball and said socket are horizontally and vertically aligned, a vertical C-shaped strut in association with said hitch, means for clamping said C-shaped strut on said neck of said ball including a horizontally directed yoke, said C-shaped strut includes an upper arm in parallelism with said lower yoke, said upper arm has means on its outer end for receiving an upstanding rod therein, said tongue of said trailer having a clamp placed on an outer surface of said inverted socket, means on an apex of said clamp for receiving another rod therein in parallelism with said upstanding rod on said C-shaped rod.

2. The visual alignment device of claim 2, wherein vertical axes of said upstanding rod on said upper arm of said C-shaped strut and said ball are horizontally offset from each other.

3. The visual alignment device of claim 1, wherein said lower yoke is removably attached to said C-shaped strut.

4. The visual alignment device of claim 1, wherein said clamp on said outer surface of said inverted socket includes at least three arms in intimate and clamping contact with said outer surface.

5. The visual alignment device of claim 4 including a magnetic strip placed on an inside surface of each of said arms to increase the holding power of said clamping arms.

6. The visual alignment device of claim 1 including reflector tapes placed at a top end of each of said upstanding rods.

7. The visual alignment device of claim 1 including means for telescoping various sections of said upstanding rods relative to each to change the vertical height of each of said upstanding rods.

8. The visual alignment device of claim 7 including means for clamping the various telescoping sections of said upstanding rods relative to each other.
